(19) United States
(12) Patent Application Publication
(10) Pub. No.: US 2013/0314269 A1
(43) Pub. Date: Nov. 28, 2013

(54) SYSTEM FOR DETERMINING THE PRESENCE OF AN IDENTIFIER INSIDE A PASSENGER COMPARTMENT

(71) Applicant: Luc Jansseune, Venerque (FR)

(72) Inventor: Luc Jansseune, Venerque (FR)

(73) Assignee: CONTINENTAL AUTOMOTIVE FRANCE, Toulouse (FR)

(21) Appl. No.: 13/984,600

(22) PCT Filed: Feb. 3, 2012
(86) PCT No.: PCT/EP2012/000492

§ 371 Date: Aug. 9, 2013

(30) Foreign Application Priority Data
Feb. 9, 2011 (FR) 1100396

(51) Int. Cl. G01S 11/02

(52) U.S. Cl. CPC G01S 11/02
USPC 342/44

(57) ABSTRACT

A system for determining the presence of an identifier (7, 7′) inside a passenger compartment (2), such as a passenger compartment (2) of a motor vehicle (1), includes:
a fixed transmitter (3), associated with the passenger compartment (2), including at least one transceiver (4) and at least one processing unit (5);
at least one mobile identifier (7, 7′) including a transceiver (8, 8′) and a processing unit (9, 9′),
the respective transceivers (4, 8, 8′) of the transmitter (3) and of the identifier (7, 7′) being capable of exchanging wireless signals; and
a comparison unit capable of comparing a signal, originating from the identifier (7, 7′), received by the transmitter (3), with at least one characteristic signature of the inside of the passenger compartment (2), the identifier (7, 7′) being assumed to be located inside the passenger compartment (2) when the comparison unit returns a positive comparison result.

The technical field of the present invention is that of systems for identifying and for controlling access to a passenger compartment, such as a passenger compartment of a motor vehicle. More particularly, the invention relates to a system for determining the presence of an identifier inside such a passenger compartment.

In the field of identification systems for vehicles, it is known practice to equip a vehicle with a fixed transmitter comprising a transceiver making it possible to communicate by wireless transmission with a mobile identifier itself fitted with a compatible transceiver. The wireless transmission is currently carried out wirelessly on LF or RF bands. Such an arrangement can with difficulty locate an identifier in order to determine whether it is inside or outside the passenger compartment. At the very least such a detection makes it necessary to have, in the segment linked to the vehicle, at least one transceiver or at least one antenna inside the passenger compartment and at least one transceiver or at least one antenna outside the passenger compartment. In practice, some systems comprise more than six antennas.

The invention proposes to produce a system for determining the presence of an identifier and for discriminating between the inside and outside relative to the passenger compartment, by using, for the segment linked to the vehicle, only one transceiver and only one antenna.

The subject of the invention is a system for determining the presence of an identifier inside a passenger compartment, such as a passenger compartment of a motor vehicle, comprising: a fixed transmitter, associated with said passenger compartment, comprising at least one transceiver and at least one processing unit, at least one mobile identifier comprising a transceiver and a processing unit, said respective transceivers of the transmitter and of the identifier being capable of exchanging wireless signals, said system also comprising a comparison means capable of comparing a signal, originating from said identifier, received by the transmitter, with at least one characteristic signature of the inside of said passenger compartment, said identifier being assumed to be located inside the passenger compartment when the comparison means returns a positive comparison result.

According to another feature of the invention, the system also comprises a storage means capable of recording a characteristic signature, said characteristic signature being predetermined on the basis of a signal received by a transmitter, originating from an identifier placed at a given point of the inside of said passenger compartment.

According to another feature of the invention, the system also comprises a preprocessing means capable of preprocessing a characteristic signature in order to determine a min./max. range, and in that the comparison means is capable of returning a positive comparison result if a signal originating from the identifier is included in said min./max. range of the characteristic signature according to a proportion at least equal to a given acceptance threshold.

According to another feature of the invention, the system also comprises: a normalization means, capable of normalizing the power of the received signal as a function that is inversely proportional to a received-signal power-level measurement.

According to another feature of the invention, the system also comprises: a measuring means capable of measuring a distance between the transmitter and the identifier, a decision means capable of carrying out the following processing: if said distance is less than a first threshold R1, the identifier is assumed to be situated on the inside, if said distance is greater than a second threshold R2, the identifier is assumed to be situated on the outside, if said distance is between said first threshold R1 and said second threshold R2, the signal, originating from said identifier, received by the transmitter, is transmitted to the comparison means for comparison with at least one characteristic signature of the inside of said passenger compartment.

According to another feature of the invention, the first threshold R1 corresponds to the radius of a circle drawn in said passenger compartment, centered on the antenna of the transceiver of the transmitter.

According to another feature of the invention, the second threshold R2 corresponds to the radius of a circle circumscribed to said passenger compartment, centered on the antenna of the transceiver of the transmitter.

According to another feature of the invention, the distance-measuring means comprises: an emission means capable of emitting from at least one of the devices, amongst the transmitter and the identifier, a signal, a returning means capable of receiving and of returning, from the other device, said signal, to the emitting device, a reception means capable of receiving, from the emitting device, said returned signal, a time-stamping means capable of comparing an emission time and a reception time, in order to determine a time of flight, a translation means capable of translating said time of flight into a distance between the two devices.

According to another alternative feature of the invention, the distance-measuring means comprises: an emission means capable of emitting from at least one of the devices, amongst the transmitter and the identifier, a time-stamped message, a reception means capable of receiving, from the other device, said time-stamped message, a time-stamping means capable of comparing an emission time contained in said message and a reception time, in order to determine a time of flight, a translation means capable of translating said time of flight into a distance between the two devices.

According to another feature of the invention, the reception means is capable of eliminating any possible multiple receptions and of considering only the reception time of a first reception.

According to another feature of the invention, the distance-measuring means also comprises a means for transmitting the determined distance value, from the device that has determined it, to the other device.

According to another feature of the invention, the distance-measuring means also comprises an averaging means capable of calculating an average between a distance determined by one device and a distance determined by the other device and transmitted.

According to another feature of the invention, the system also comprises a reduction means capable of reducing the signals exchange frequency, between the identifier and the transmitter, while the measured distance remains substantially constant.

According to another feature of the invention, the transceivers are capable of using a modulation wherein the signals are exchanged by means of pulses of very short duration.

According to another feature of the invention, the transceivers are capable of using a multi-channel redundant modulation, the comparison means is capable of comparing a signal transmitted via a first channel, and the system comprises at least one additional comparison means capable of comparing a signal transmitted via another channel, and an arbitrating means capable of arbitrating a final comparison result as a function of the respective comparison results of the comparison means.

According to another feature of the invention, the transceivers are capable of using a very high frequency modulation in the band between 4 GHz and 6.5 GHz.

According to another feature of the invention, the transceivers are capable of using a UWB wireless modulation, that is to say an ultra wide band modulation.

The invention also relates to a transmitter capable of being incorporated into such a system, considered on its own.

The invention also relates to an identifier capable of being incorporated into such a system, considered on its own.

Other features, details and advantages of the invention will emerge more clearly from the detailed description given below as an indication with reference to drawings in which:

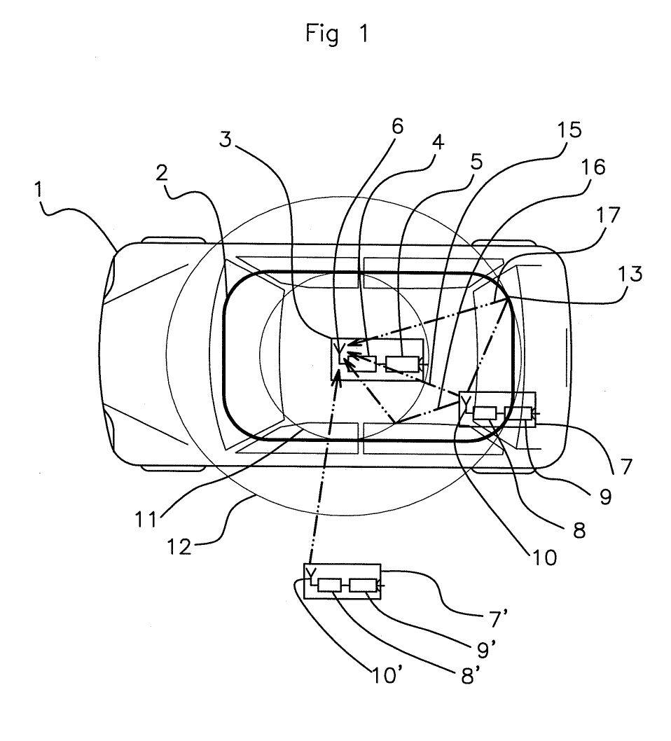

FIG. 1 shows a view from above of a system according to the invention applied to a motor vehicle,

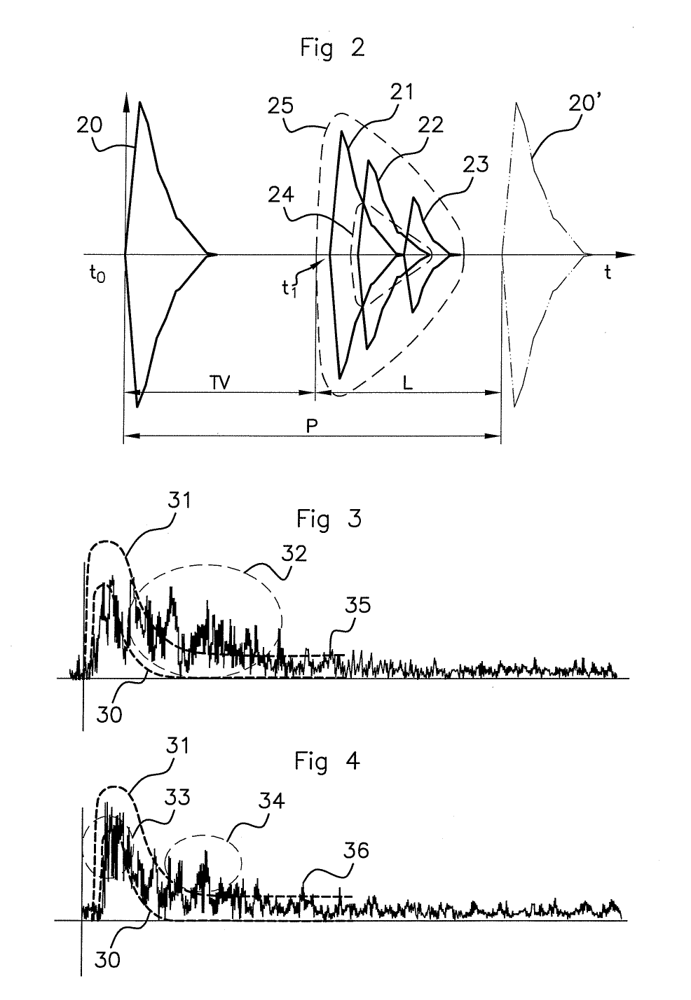

FIG. 2 illustrates the multiple reception of a pulse,

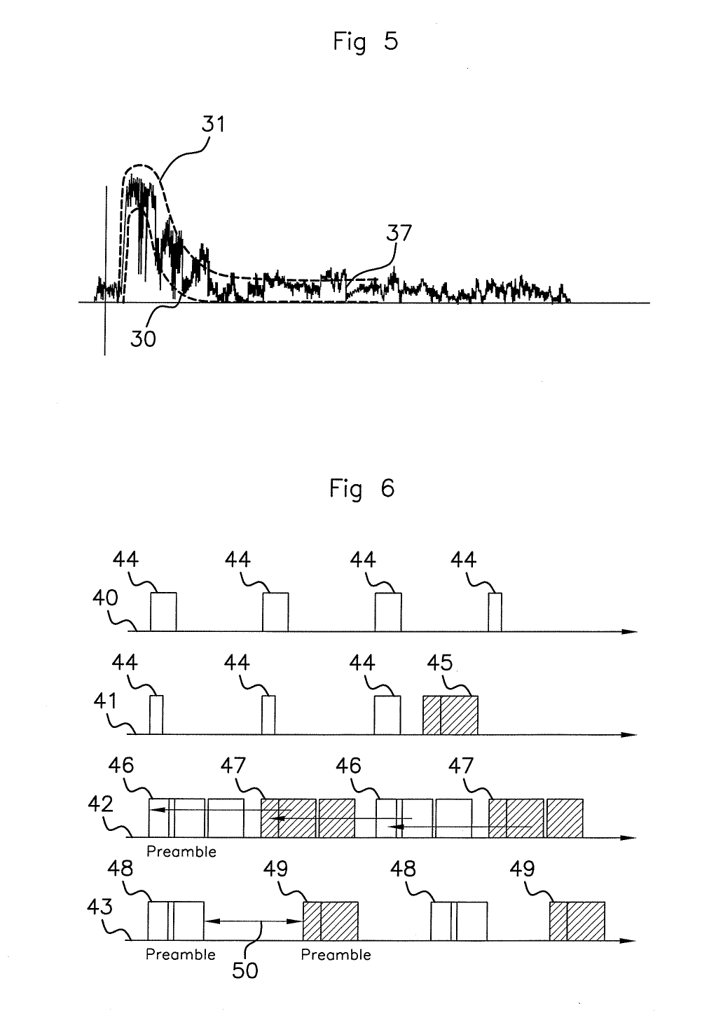

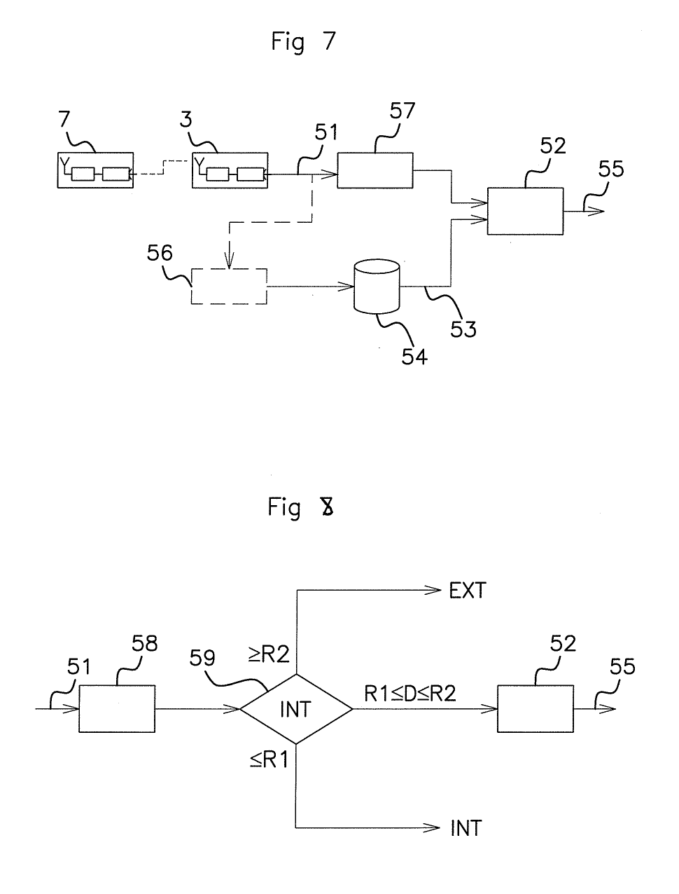

FIGS. 3, 4 and 5 illustrate a received signal and its inside/outside discrimination,

FIG. 6 shows timing diagrams detailing an employed protocol,

FIG. 7 shows a functional block diagram of the discrimination means by comparison with a characteristic signature,

FIG. 8 shows a functional block diagram of the discrimination means by distance measurement.

FIG. 1 shows an overview from above of a typical system according to the invention, applied to a motor vehicle 1.

The system is capable of determining and of verifying the presence of an identifier 7 inside a passenger compartment 2 of said vehicle 1. The system comprises a fixed transmitter 3, associated with said passenger compartment 2/vehicle 1, in which it is installed in a fixed position. This transmitter 3 comprises at least one transceiver 4 and at least one processing unit 5 for processing the information. The transmitter 3 is advantageously connected to other systems of the vehicle 1.

The system also comprises at least one mobile identifier 7, 7′. An identifier 7, 7′ comprises a transceiver 8, 8′ and a processing unit 9, 9′. The two devices, transmitter 3 and identifier 7, 7′, are substantially identical in function.

In FIG. 1, the reference numbers 7-10 are associated with an identifier 7 placed inside the passenger compartment 2, while the reference numbers 7′-10′ are associated with an identifier 7′ placed outside the passenger compartment 2.

The transceiver 4 of the transmitter 3 and the transceiver 8 of the identifier 7 are substantially identical and are capable of exchanging wireless signals.

The hardware of the processing units 5, 9 is substantially identical. The onboard software programs can, if necessary, differ depending on the different envisaged processings.

An identifier 7, 7′ is small enough and self-sufficient power wise to be able to be carried by a user of the vehicle 1. Because of the identifier miniaturization, the antenna 10, 10′ of the identifier 7, 7′ is reduced to the minimum. On the other hand, the antenna 6 of the transmitter 3 placed in the vehicle, where the volume is less restricted, can be larger.

The system according to the invention is typically incorporated into a hands-free access control system. The transmitter 3 is included in the segment associated with the vehicle, while the identifier 7 is incorporated into the “key” carried by a driver. The identifier 7, 7′ communicates with the transmitter 3 and exchanges messages allowing authentication. This authentication allows an identification of the carrier of identifier 7, 7′ as an authorized driver. A positive identification therefore makes it possible to control various functions such as locking/unlocking of the doors, authorization to start the engine, ambience lighting, etc. The key is known as virtual in that it is no longer inserted mechanically into a lock, but can remain in the pocket of the driver. It needs only to be close to the transmitter 3. This is advantageous for the driver for whom the use of said key/identifier is greatly simplified. However, it also has the consequence that said identifier 7, 7′ is no longer located accurately.

For reasons of safety, the regulations require, for the authorization to start the engine, that (at least) one identifier 7 be present inside the passenger compartment 2. This presence must be able to be determined with an accuracy of 10 cm. This justifies the system according to the invention, capable of discriminating with accuracy and certainty whether the identifier 7, 7′ is inside or outside the passenger compartment 2.

In order to carry out this inside/outside discrimination function, of which a functional diagram is shown in FIG. 7, the system comprises a comparison means 52. This comparison means 52 is capable of comparing a signal 51 with at least one characteristic signature 53 of the inside of the passenger compartment 2. The signal 51 is received in real time by the transmitter 3 via its transceiver 4. This signal 51 originates from the identifier 7, 7′. The characteristic signature(s) 53 is/are stored in a storage means 54. The comparison means 52 carries out a comparison test and produces a result 55, which is positive when the signal 51 is comparable with at least one of the characteristic signatures 53, and negative when the signal 51 is not comparable with any of said characteristic signatures 53. The result 55 of this test is used to carry out the desired discrimination. The identifier 7 is assumed to be located inside the passenger compartment 2 when the comparison means 52 returns to a positive comparison result. It is assumed to be outside if the comparison means 52 returns a negative comparison result 55.

Unlike the signal 51 which is read directly from an identifier 7, 7′ that is emitting and present in the reception range of the transmitter 3, a characteristic signature 53 is predetermined. This predetermination is typically carried out during a characterization phase at the end of design/manufacture of the vehicle 1, or at least for a series of comparable vehicles 1, with respect to their radio frequency behavior.

The processing of characterization is shown as a dashed line in the diagram of FIG. 7. A characteristic signature 53 is obtained from a signal sent by a characterization identifier similar to the identifier 7, 7′ or an equivalent device capable of emitting a signal similar to the signal 51. Said identifier/device is placed inside the passenger compartment 2 of the vehicle 1 in a given location. This signal is received by a characterization transmitter, similar to the transmitter 3. The characteristic signature 53 is recorded and stored so that it can be restored subsequently to the comparator means 52 and used for comparison purposes.

If characteristic signatures that can be observed in different locations inside the passenger compartment 2 are sufficiently close to one another, it may be sufficient to store only one characteristic signature 53. The latter is then assumed to be indicative of any point situated inside the passenger compartment 2. However, because of the complex construction of a passenger compartment 2, this is most frequently not possible. It is therefore necessary to increase the number of locations inside the passenger compartment 2, each being associated with a characteristic signature 53, in order to form a set of representative characteristic signatures. Ideally, this set has a cardinal number that is as small as possible, and such that a signal emitted by an identifier 7, 7′ from any location inside the passenger compartment 2 is comparable with at least one of the characteristic signatures of said set. “Comparable” is understood in this instance in the sense of the comparator means 52 and of its acceptance tolerances.

A characteristic signature 53 may, according to a first embodiment, be directly the signal received by a characterization transmitter, for example in the form of a power curve received as a function of time.

According to a second embodiment, a characteristic signature 53 advantageously results from a preprocessing, for example carried out by a preprocessing means 56, using from the received signal only a min./max. range 53 of this signal. This min./max. range may for example be produced by time-averaging of the signal over a time horizon. It is also possible to apply an additional tolerance around each point of the curve.

This is advantageous in that such a min./max. range is a simpler curve than the curve of the initial signal. The preprocessing therefore makes it possible to reduce the quantity of storage 54 that is necessary. Moreover, such a min./max. range 53 simplifies the comparison operation.

With reference to FIGS. 3-5, an embodiment of the comparison operation will now be described. During the characterization step, a characteristic signature 53 has been determined for each characteristic point of the passenger compartment 2 inside. This signature has been preprocessed to obtain a min./max. range 53, 30, 31. FIGS. 3-5 each show a diagram depicting on the y axis the intensity of the radio electric power received as a function of the time on the x axis. This diagram shows the min./max. range in the form of a min. curve 30 and a max. curve 31. FIGS. 3, 4 and 5 also represent respectively a signal 35, 36, 37 to be compared with the characteristic signature 53 of which the min./max. range 30, 31 is shown.

The comparison step determines whether the received signal 35-37 is included in the min./max. range 30, 31. In order to take account of the variability of the wireless signals, a certain proportion or inclusion rate of the signal 51, 35-37 in the range 30, 31 is considered. In practice, a proportion of 70% has been found to be a satisfactory value for accepting a “close”, even noisy, signal while rejecting a signal that is more “distant”.

The signal 35 of FIG. 3 is only very weakly superposed on the min./max. range 30, 31. A considerable portion, notably in the zone 32 is a long way outside the min./max. range 30, 31 in that it goes above the max. curve 31. In the present case, the comparison returns a negative comparison result 55.

The signal 36 of FIG. 4 is also not superposed on the min./max. range 30, 31. A considerable proportion is a long way outside the min./max. range 30, 31. The zone 33 shows a considerable portion of the signal 36 below the min. curve 30. The zone 34 shows a considerable portion of the signal 36 above the max. curve 31. In the present case, the comparison returns a negative comparison result 55.

The signal 37 of FIG. 5 is sufficiently well superposed on the min./max. range 30, 31. A considerable portion, greater than a chosen threshold proportion, is included in the min./max. range 30, 31. In the present case, the comparison returns a positive comparison result 55.

If several characteristic signatures are used, a signal 51 is compared with these various characteristic signatures. If the comparison with at least one characteristic signature 30, 31 is positive, the signal 51 is assumed to be emitted from an identifier 7 placed inside the passenger compartment 2. On the other hand, for the signal to be assumed to be emitted from an identifier 7 placed outside the passenger compartment 2, the comparison of this signal 51 with all the characteristic signatures must return a negative comparison result 55.

Since radio signal intensities are compared, it is advantageous to compare comparable quantities. For this, a normalization is advantageously carried out on the signal 51, advantageously when it is received. For this, a received-signal power level is used. Such a level is typically supplied by the radio receiver and is called RSSI (Received Signal Strength Indication). The normalization carried out for example by a normalization means 57 consists in applying a linear increase of the power inversely proportional to the received-signal power level. Thus, for example, for a received-signal power level of 50%, the received-signal power 51 is normalized by multiplication by a factor of two. This normalization is advantageously applied to all the received signals, including during the characterization. Thus the comparison operation compares signals that are comparable in power in order to concentrate the comparison on the shape of these signals.

Only the use of the characteristic signatures 53 compared with a received signal 51 as described above is possible. However, the method may be further improved by taking a distance measurement.

As illustrated in FIG. 1, a distance measurement, taken by a radio receiver based on a received signal 51 makes it possible to situate an emitter on a circle around a receiver or more precisely around its antenna. If the distance D between the identifier 7, 7′ and the transmitter 3 is known, this makes it possible to roughly locate the identifier 7, 7′ relative to the transmitter 3 and hence relative to the passenger compartment 2. Unfortunately, the passenger compartment does not usually have a circular shape, but rather a complex shape, shown here in an illustrative manner by a rectangle 2. Moreover, as illustrated by FIG. 1, the transmitter 3, or more precisely its antenna 6, is not necessarily placed in the center of the passenger compartment 2. However, a distance measurement can make it possible to accelerate the inside/outside discrimination in the following manner.

With reference to FIG. 8, the use of a distance measurement will now be described. A measuring means 58 determines a distance D between the transmitter 3 and the identifier 7, 7′ by one of the several methods that will be proposed below. This distance D is processed by a decision means 59 capable of carrying out an initial filter processing according to the following outline. If the distance D is below a first threshold R1, the identifier 7, 7′ is assumed to be situated inside the passenger compartment 2. If the distance D is above a second threshold R2, the identifier 7, 7′ is assumed to be situated outside the passenger compartment 2. It goes without saying that R2 is above R1. These first two tests make it possible to rapidly process many cases without risk of dispute. On the other hand, if the distance D is between said first threshold R1 and said second threshold R2, the signal 51 originating from the identifier 7 is transmitted to the comparison means 52 for comparison with at least one characteristic signature of the inside of the passenger compartment 2, as described above. The comparison means 52 is used only in this case and returns a result 55.

With reference to FIG. 1, it is possible to give a physical sense to the two thresholds R1 and R2. Although the passenger compartment 2 is not circular and can have any shape, it is possible to frame it between two circles, both centered on the antenna 6 of the transceiver 4 of the transmitter 3.

A first circle, drawn in said passenger compartment 2, defines a radius R1. If the distance D is less than R1, it is certain that the identifier 7 is situated in this first circle and therefore inside the passenger compartment 2.

A second circle, circumscribed in said passenger compartment 2, defines a radius R2. If the distance D is greater than R2, it is certain that the identifier 7 is situated outside this second circle and therefore outside the passenger compartment 2.

If the distance D is between R1 and R2, the identifier 7 is in a zone of doubt, between the two circles. In this case, the comparison method with the characteristic signatures 53 is applied.

Measuring the distance between the transmitter 3 and the identifier 7 is essentially carried out by measurement of time of flight of a signal/message identified by a characteristic element that can be detected by a receiver. This particular element may be a particular data message or a pulse of greater intensity or any other characteristic of the radio signal or of its content.

At least two methods can be used to carry out the measurement of distance D between the two devices that are the transmitter 3 and the identifier 7, 7′.

According to a first method, the distance-measuring means 59 comprises an emission means. This emission means is capable of emitting a signal from one of the two devices 3, 7, 7′. The other of the two devices 3, 7 then comprises a returning means capable of receiving said signal and of returning it immediately to the emitting device. Said emitting device comprises a reception means capable of receiving said returned signal. The emitting device, which in this instance is also the receiving device, records the time at which it has emitted the signal and the time at which it has received the returned signal. A time-stamping means, typically placed downstream of the reception means, compares the emission time and the reception time thus recorded. The difference between these two times determines a time of flight TV of said signal. Since the measurement is taken over a round trip, the time of flight TV is doubled here.

Since the speed of radio signals in the air is known and considered to be substantially constant, a translation means translates this time of flight TV into a distance D between the two devices 3, 7.

According to a second method, the distance-measuring means 59 comprises an emission means. This emission means is capable of emitting from one of the two devices 3, 7, 7′ a time-stamping message, typically by means of an emission time included in the message itself. The other of the two devices 3, 7 then comprises a reception means capable of receiving said message. On receipt, the reception means records the time at which it received the message. A time-stamping means, typically placed downstream of the reception means, compares the emission time contained in the message and the reception time recorded by the reception means. The difference between these two times determines a time of flight TV of said message/signal.

Since the speed of radio signals in the air is known and considered to be substantially constant, a translation means translates this time of flight TV into a distance D between the two devices 3, 7.

According to the frequency band used to communicate between the transmitter 3 and the identifier 7, it is possible that the signal, when it is transmitted, is reflected on the various obstacles that may be present. The result of this is that the signal 51 will be multiplied by the environment and received by the receiver with reception times that are as much shifted as the path followed has been extended by the possible reflections. All these multiplications of the signal due to the multiple reflections are superposed on a single signal received by the receiver.

FIG. 2 illustrates this phenomenon by means of a diagram showing the radio power as a function of time. The emitter emits, at the moment t₀, an initial signal 20. After transmission, the receiver receives, at the moment t₁, a first signal 21, with a shape similar to the initial signal 20, with a slight attenuation due to the traveled path, this signal 21 corresponding in all probability to a direct, online transmission. A little later, it receives a second signal 22 corresponding in all probability to a 1^{st} reflected signal. The reflection increases the length of the path. This causes the delay relative to the time t₁ of reception of the signal 21. Moreover, the reflection itself and the increased length of the path cause an attenuation of the signal that is greater relative to that of the signal 21. Again a little later, the receiver receives a signal 22 corresponding to a 2^{nd} reflected signal. All these signals are superposed on the receiver.

The existence of multiple reflections, often prejudicial in radio transmission, is made use of according to one embodiment of the invention which is described below.

With respect to the time of flight TV and the distance measurement D, the receiver should consider the shortest distance and hence the straight-line path. This corresponds to the first or to the beginning of the received signal and is therefore easy to differentiate, including in the presence of superposed signals. The time of flight TV is equal to the difference of the moments t₁ and t₀. The receiver easily removes the multiple reflections since they are necessarily delayed. It is therefore necessary to retain only the beginning t₁ of the received signal. In the worst case in which the direct path is totally interrupted by an obstacle, the multiplicity of the multiple paths is an advantage. Specifically, in this case there is a path with reflection that is not very different, in terms of length, from the direct path. This is particularly verifiable inside the passenger compartment 2, because the walls 13 of said passenger compartment 2 are present and produce many reflections of the signals. The error, on the high side, produced on the distance measurement therefore remains very limited. At the very least, this error remains less than the 10 centimeters demanded by the regulations.

On the basis of the principle of time of flight, it is possible to develop several distance-measuring methods. According to a first method, the identifier 7 comprises the emission means, and the transmitter 3 comprises the reception means and the comparison means. The distance D is then determined by the transmitter 3. According to a second method, the transmitter 3 comprises the emission means, and the identifier 7 comprises the reception means and the comparison means. The distance D is then determined by the identifier 7.

According to a third method, the distance is determined by either one of the two devices 3, 7, and then transmitted to the other device by means of a radio message. In this case, the distance-measuring means 58 advantageously comprises a transmission means. This means may for example construct a data message containing the distance measurement D previously determined by a device 3, 7 and send it to the other device 3, 7.

A fourth method combines the first methods. It is possible to determine the distance measurement D on any one of the two devices 3, 7. It is also possible to receive at a device 3, 7 the measurement determined and transmitted by the other device. This leads to having on a given device 3, 7 a distance determined locally and a distance determined by the other device 3, 7. It is then possible to add to the distance-measuring means 58 an averaging means capable of calculating an average between these two distances, local and transmitted, considered to be identical. The average thus obtained is a new distance measurement D. Its accuracy is statistically better, since an error on one of the two determinations of the distance D is divided by two. A simultaneous error on both measurements is very unlikely.

With reference now to FIG. 6, a message-exchange protocol will be described that can be employed between the transmitter 3 and an identifier 7, 7′. FIG. 6 shows 4 lines of timing diagrams 40-43. In light color are shown the messages emitted by the transmitter 3, while in gray colors are shown the messages emitted by the identifier 7. The messages consist of blocks. It is possible to distinguish short blocks also called preambles and longer blocks called data. A preamble identifies its emitting device and contains the elements necessary for the synchronization of the two devices 3, 7.

The first line 40 shows a first mode in which the transmitter 3 is on its own. In the absence of an identifier 7 in its range, the transmitter 3 is in search mode and emits periodically a simple message 44 reduced to a preamble block. This continues periodically until an identifier 7 enters the range.

As illustrated on the second line 41, the identifier 7 receives a message 44, identifies the transmitter 3 as being that with which it is paired, synchronizes itself and responds with a message 45. This message 45 comprises a preamble of the identifier 7 followed by a data block. This data block may, for example, comprise the distance measurement D made by the identifier 7 in order to transmit it to the transmitter 3.

Various exchanges are then carried out between the transmitter 3 and the identifier 7 in order to be able to collaborate. Thus, a recognition and authentication step can be carried out as illustrated on the line 42.

The authentication begins by the emission by the transmitter 3 of a request message 46 consisting of a preamble block followed by a first data block and a second block requesting authentication. The identifier 7 responds to this request with a response message 47 consisting of a preamble block followed by a first data block and a second block for authentication response. If this response is satisfactory, the dialogue continues according to a nominal mode illustrated on the line 43 in which the transmitter 3 and the identifier 7 exchange periodically respectively messages 48, 49, both consisting of a preamble block followed by a single data block. This data block may, for example, comprise the distance measurement D made by one of the two devices 3, 7 which is thus transmitted to the second device 3, 7.

It is notable that most of the needs of information interchange between the two devices 3, 7 are situated at the beginning when the identifier 7 enters the range of the transmitter 3. Then a less demanding standby dialogue is sufficient to update the few items of information necessary, notably the distance D. In this standby mode it is notably necessary to verify that the identifier 7 does not cross the border between the inside and outside. Monitoring of the distance D between the two devices 3, 7 is advantageously carried out in order to detect any change.

It may be noted that, in the steady state, the identifier 7 does not move relative to the vehicle 1. This case can be easily identified in that the distance D between the two devices 3, 7 remains substantially constant. In this instance, a tolerance is advantageous for taking account of the variability of the radio transmissions and of the distance measurements D. This case may be used to reduce the mutual frequency of the interchanges of messages 48, 49 between the two devices. The period 50 that separates a message 48 from a message 49 and a message 49 from a message 48 can therefore be very markedly increased.

Advantageously, such a reduction in the frequency makes it possible, by reducing the radio emissions, to reduce the associated power consumption. This is particularly profitable for the identifier 7, 7′ which has a very small cell or battery.

It should be noted that, for this function, it is not necessary to distinguish the case in which the identifier 7 is inside from that in which it is outside the passenger compartment 2. Specifically, if the identifier 7 is inside the passenger compartment 2, it may be assumed that the vehicle 1 is used. The system is in a standby mode as previously described in which the low data-exchange requirement tolerates a reduction in the frequency of exchange. If, on the other hand, the identifier 7 is outside the passenger compartment 2, still immobile, it may be assumed that the vehicle 1 is not used. This second case corresponds typically to a storage of the identifier 7, 7′ close to the vehicle 1 (in the range of the transmitter 3), a situation which may last a very long time. The function of reducing the exchange frequency is in this instance particularly advantageous in that it makes it possible to extend the service life of the identifier 7 cell. The gain in extension thus obtained is of the order of the said frequency reduction factor. The above two situations are different but can be treated in the same manner.

The type of radio frequency modulation employed by the transceivers has not been mentioned hitherto. It is a result of the features used by the invention that any modulation can be used.

However, a modulation in which the signals are exchanged by means of pulses of very short duration is preferable. Such a modulation is advantageous in several respects. It has been seen with respect to FIG. 2 and the distance measurement per time of flight that it is advantageous for measuring said time of flight to have an emission moment t₀ well marked at the emitted signal in order to find a moment of reception t₁ that is well marked also at the received signal, and this is so despite the spread of the signal because of the multiple reflections.

A modulation in which the signals are exchanged by means of pulses of very short relative duration is also advantageous for the method for comparing the received signal 51 with a characteristic signature 53. Thus, as illustrated in FIG. 2, using only a relatively short duration with a period P to emit a signal 20 has the effect of producing a clear separation of the successive received signals.

An emitted signal 20 typically produces a received signal which is the superposition of the various multiple reflections 21-23. The very short relative duration allows the emission (and hence reception) period P, which separates two successive emissions 20 and 20′ (and similarly two successive receptions) to be sufficiently large compared with the duration L of spread of a received signal 21-23, so that two successive received signals are not superposed, while taking account of the spread L of the received signal 21-23 because of the different respective delays of the various multiple paths.

This makes the characterization step easier and makes it possible to determine a characteristic signature 53 that is dependent only on the received signal pattern, with no interference with the previous or next received signal.

Thus the determination of a range can be achieved in the form of a min. curve 24 and of a max. curve 25 which encompasses the pattern of a single received signal. The comparison of a received signal 21-23 with such a min./max. range 24-25 is thereby made easier.

The system according to the invention advantageously uses the existence of multiple reflections according to the multiple paths to increase the discriminating separation between the inside and the outside of the passenger compartment 2.

With reference jointly to FIGS. 1 and 2, this will be explained. Consideration is given to a first identifier 7 situated inside the passenger compartment 2 and a second identifier 7′ situated on the outside.

A signal emitted by the first identifier 7 will give rise to a direct path 15. Because of the passenger compartment 2 very presence and of its walls 13 all around the identifier 7, the emitted signal will be reflected on said walls 13 and again give rise to very many other paths. Two examples of such paths are illustrated by the references 16 and 17.

With reference now to FIG. 2, the emitted signal 20 gives rise to a first reception 21 corresponding to the direct path 15. The receptions 22 and 23 correspond respectively to the paths 16 and 17. All the receptions 21-23 are superposed to produce the received signal.

A signal emitted by the second identifier 7′ will give rise to a direct path 15′. It is possible that this signal is reflected on obstacles associated with the environment or even with the vehicle 1. However, there are fewer obstacles likely to reflect the emitted signal in comparison with the inside case. The outside walls of the passenger compartment 2 in this instance tend to form an obstacle to some of the multiple paths which are not then received. The result of this is that the multiple paths, in the outside case, tend to be less numerous than in the inside case. Moreover, the obstacles are usually further away from the identifier 7′. The result of this is that the multiple paths tend on average to be longer.

The result of this is well-differentiated received-signal shapes. As can be seen in FIGS. 3-5, a curve 37 of a received signal from an identifier 7 situated inside the passenger compartment 2, as shown in FIG. 5, will be much closer together in time, concentrated against the y axis and have an amplitude that is very quickly attenuated. On the other hand, a curve 35, respectively 36, of a received signal from an identifier 7′ situated outside the passenger compartment 2, as shown in FIG. 3, respectively FIG. 4, will be more spread in time and have a considerable amplitude for longer.

This feature is very discriminating between an identifier 7 inside the passenger compartment 2 and an identifier 7′ outside the passenger compartment 2, and makes it easier to discriminate between the two cases by comparison of the curves.

According to one advantageous variant of the invention, it is also possible to use a multi-channel redundant modulation. Thus, an emitter, instead of emitting a signal 21 to a receiver, emits n times a signal with the same content as the signal 21 but over n different and independent channels. The n channels typically differ in that they use different frequencies. Thus, if a frequency is scrambled or disrupted or stopped by an obstacle, there is little chance that the n-1 other channels are also. The chance of achieving a correct transmission therefore increases. This applies to both the message transmission and the distance measurement. The chance of achieving a direct path is therefore increased.

All of the elements of the system are duplicated in order to process these redundant channels. This gives a comparison means 52 and at least one characteristic signature 53 which are associated with each of these n channels. It is possible that the comparison results differ depending on the channel. For an identifier 7 situated on the inside, it is possible that a disruption or an obstacle falsifies a comparison result 55 which appears negative on one channel. However, statistically, this result 55 is falsified only on a minority of channels. Thus, out of the n comparison means 52, a minority returns a falsified (outside) comparison result 55 and a majority returns a correct (inside) comparison result 55. An arbitrating means can arbitrate, for example in favor of the majority result, in order to determine the correct (in this instance inside) final comparison result. A similar operation can be applied in the contrary case of an identifier 7′ situated on the outside, even though in this case a falsified result is less likely.

Such a multiplication of the number of channels provides increased robustness relative to a monochannel system which is mistaken in the situation in which the single channel is disrupted.

Also advantageously, it is possible to use a very high frequency modulation, for example in the band between 4 GHz and 6.5 GHz. Such a frequency band, very far from the resonance frequency of water, allows human bodies to be transparent to the radio signals. Thus a device 3, 7 does not have its signals disrupted by the presence vehicle 1 user or passenger, who is frequently close by, an identifier 7 being most frequently carried in the hand or in a pocket of clothing.

Such a frequency band also advantageously makes it possible to produce short pulses while allowing a considerable information bit rate.

This short-pulse feature advantageously allows a fine resolution of the distance measurement which notably makes it possible to ensure an accuracy of less than 10 cm in the inside/outside discrimination.

Such a frequency band also promotes the multiple reflections on the various materials of the walls 13 of the passenger compartment 2, thus enhancing the difference in the received signal curves shape and making it easier to discriminate between inside and outside.

This beneficial feature of using the multiple reflections advantageously makes it possible to considerably reduce the number of transmitters 3 and/or of associated antennas 4 to place in a vehicle 1. A single transmitter 3 and a single antenna is usually sufficient for a system for most vehicle architectures. It is however always possible to add a second transmitter or a second antenna to the first transmitter 3 in order to cover particular zones such as the trunk of the vehicle 1.

According to a preferred embodiment, the transceivers of the system use a UWB wireless modulation. This ultra wide band modulation standard combines various previously-described advantages: it involves a high frequency modulation, in the band between 4 GHz and 6.5 GHz, the signals are transmitted by means of very short pulses and redundancy is obtained by the use of 15 parallel channels.

Added to these aforementioned advantages, is that of being a standard. This ensures the existence of transceivers available off the shelf and a simplification of the regulatory aspects such as obtaining radio transmission licenses.

Furthermore, the UWB standard is designed to be employed by cellphones. It is therefore possible to produce an identifier 7 with all its functions as described above by configuring a cellphone.

1. A system for determining the presence of an identifier (7, 7′) inside a passenger compartment (2), such as a passenger compartment (2) of a motor vehicle (1), comprising:
a fixed transmitter (3), associated with said passenger compartment (2), comprising at least one transceiver (4) and at least one processing unit (5),
at least one mobile identifier (7, 7′) comprising a transceiver (8, 8′) and a processing unit (9, 9′),
said respective transceivers (4, 8, 8′) of the transmitter (3) and of the identifier (7, 7′) being capable of exchanging wireless signals,
characterized in that it comprises a comparison means (52) capable of comparing a signal (51), originating from said identifier (7, 7′), received by the transmitter (3), with at least one characteristic signature (53) of the inside of said passenger compartment (2), said identifier (7, 7′) being assumed to be located inside the passenger compartment (2) when the comparison means (52) returns a positive comparison result (55).

2. The system as claimed in claim 1, also comprising a storage means (54) capable of recording a characteristic signature (53), said characteristic signature (53) being predetermined on the basis of a signal received by a transmitter (3), originating from an identifier (7) placed at a given point of the inside of said passenger compartment (2).

3. The system as claimed in claim 1, also comprising a preprocessing means (56) capable of preprocessing a characteristic signature in order to determine a min./max. range (53), and in that the comparison means (52) is capable of returning a positive comparison result (55) if a signal (51) originating from the identifier (7) is included in said min./max. range (53) of the characteristic signature according to a proportion at least equal to a given acceptance threshold.

4. The system as claimed in claim 1, also comprising:
a normalization means (57), capable of normalizing the power of the received signal (51) as a function that is inversely proportional to a received-signal power-level measurement.

5. The system as claimed in claim 1, also comprising:
a measuring means (58) capable of measuring a distance between the transmitter (3) and the identifier (7, 7′),
a decision means (59) capable of carrying out the following processing:
if said distance is less than a first threshold R1, the identifier (7, 7′) is assumed to be situated on the inside,
if said distance is greater than a second threshold R2, the identifier (7, 7′) is assumed to be situated on the outside,
if said distance is between said first threshold R1 and said second threshold R2, the signal (51), originating from said identifier (7, 7′), received by the transmitter (3), is transmitted to the comparison means (52) for comparison with at least one characteristic signature (53) of the inside of said passenger compartment (2).

6. The system as claimed in claim 5, wherein the first threshold R1 corresponds to the radius of a circle drawn in said passenger compartment (2), centered on the antenna (6) of the transceiver (4) of the transmitter (3).

7. The system as claimed in claim 5, wherein the second threshold R2 corresponds to the radius of a circle circumscribed to said passenger compartment (2), centered on the antenna (6) of the transceiver (4) of the transmitter (3).

8. The system as claimed in claim 5, wherein the distance-measuring means (58) comprises:
an emission means capable of emitting from at least one of the devices (3, 7, 7′), amongst the transmitter (3) and the identifier (7, 7′), a signal,
a returning means capable of receiving and of returning, from the other device (3, 7, 7′), said signal, to the emitting device,
a reception means capable of receiving, from the emitting device (3, 7, 7′), said returned signal,
a dating means capable of comparing an emission date and a reception date, in order to determine a time of flight,
a translation means capable of translating said time of flight into a distance between the two devices (3, 7, 7′).

9. The system as claimed in claim 5, wherein the distance-measuring means (58) comprises:
an emission means capable of emitting from at least one of the devices (3, 7, 7′), amongst the transmitter (3) and the identifier (7, 7′), a dated message,
a reception means capable of receiving, from the other device (3, 7, 7′), said dated message,
a dating means capable of comparing an emission date contained in said message and a reception date, in order to determine a time of flight,
a translation means capable of translating said time of flight into a distance between the two devices (3, 7, 7′).

10. The system as claimed in claim 8, wherein the reception means is capable of deleting any possible multiple receptions and of considering only the reception date of a first reception.

11. The system as claimed in claim 8, wherein the distance-measuring means (58) also comprises a means for transmitting the determined distance value, from the device (3, 7, 7′) that has determined it, to the other device.

12. The system as claimed in claim 11, wherein the distance-measuring means (58) also comprises an averaging means capable of calculating an average between a distance determined by one device (3, 7, 7′) and a distance determined by the other device and transmitted.

13. The system as claimed in claim 1, also comprising a reduction means capable of reducing the signal frequency exchange, between the identifier (7, 7′) and the transmitter (3), while the measured distance remains substantially constant.

14. The system as claimed in claim 1, wherein the transceivers (4, 8, 8′) are capable of using a modulation wherein the signals are exchanged by means of pulses of very short duration.

15. The system as claimed in claim 1, wherein the transceivers (4, 8, 8′) are capable of using a multi-channel redundant modulation, wherein the comparison means (52) is capable of comparing a signal transmitted via a first channel, and wherein the system comprises at least one additional comparison means capable of comparing a signal transmitted via another channel, and an arbitrating means capable of arbitrating a final comparison result as a function of the respective comparison results (55) of the comparison means (52).

16. The system as claimed in claim 1, wherein the transceivers (4, 8, 8′) are capable of using a very high frequency modulation in the band between 4 GHz and 6.5 GHz.

17. The system as claimed in, wherein the transceivers are capable of using an ultra wide band modulation.

18. A transmitter (3) capable of being incorporated into a system as claimed in claim 1.

19. An identifier (7, 7′) capable of being incorporated into a system as claimed in claim 1.
